(19) United States
(12) Patent Application Publication
(10) Pub. No.: US 2022/0382759 A1
(43) Pub. Date: Dec. 1, 2022

(54) ALGORITHM FOR DATES RANGE LAYERS FOR HISTORICAL DATA

(71) Applicants: Valentin Podkamennyi, Palo Alto, CA (US); Oleksandr Krayilo, Palo Alto, CA (US); Yelyzaveta Podkamenna, Palo Alto, CA (US); Dmytro Krayilo, Palo Alto, CA (US)

(72) Inventors: Valentin Podkamennyi, Palo Alto, CA (US); Oleksandr Krayilo, Palo Alto, CA (US); Yelyzaveta Podkamenna, Palo Alto, CA (US); Dmytro Krayilo, Palo Alto, CA (US)

(21) Appl. No.: 17/334,767

(22) Filed: May 30, 2021

(51) Int. Cl. G06F 16/2455; G06F 16/21; G06F 16/22

(52) U.S. Cl. CPC G06F 16/24556; G06F 16/219; G06F 16/2291

(57) ABSTRACT

The present invention is an algorithm for storing and accessing historical data, using dates range layers. This approach is intended to aggregate almost any kind of historical data such as but not limited to web server logs, network traffic, finance transactions, marketing data, or sports statistics into dates range layers which can be saved into almost any data storage making it easily accessible as quickly as possible without extra calculations.

### FIELD OF INVENTION

The present invention is an algorithm for storing and accessing historical data using fixed date range layers.

### BACKGROUND OF INVENTION

Data storage is the process of recording (storing) information (data) in a storage medium. The most prevalent forms of data storage are file storage, block storage, and object storage, with each type being distinctly ideal for different purposes or requirements. Data storage essentially means that information is recorded digitally and saved within a storage system, such as a database, for future retrieval or usage. A database is typically an organized collection of data, generally stored and accessed electronically from a computer system. In systems where databases are more complex, they are often developed using formal design, protocols, and modeling techniques.

For many businesses, data is among the most valuable assets that supports long term strategies and enhances business growth. In the same way that complex and important decisions are made using valuable data with respect to warehousing and distribution of products, or the location of facilities or mapping of turnkey operations, including the process of determining how and where critical data is stored. These are among the most important business decisions to be made in order to strive and ensure survival within the competitive market. Today's organizations rely on their proprietary data assets to make critical business decisions, utilizing powerful algorithms to derive invaluable insights from the unstructured data they've gathered from customers, researchers, and competitors. Choosing a data storage solution can be a daunting challenge to derive the appropriate information and conclude the best decision within the interest of the company.

A database includes components for storing data and executing customized user-defined computational expressions in substantially real-time, such that the desired results can be provided to a user. For example, a database system may process stored data information related to the historical data and recordings, and can compute a series of data in response to requests from a user. The requests may include a start time, end time, a period or a specific date. The database system may retrieve a set of data identified for each period, perform arithmetic and logical operation(s) as per the user requirement to obtain data values pertaining to a specific period, date or time range.

Traditionally, historical data such as web server logs, network traffic, financial transactions, marketing data, sports statistics and so on, were stored within a database, line by line for each record. If the application needed to display the sum of a specific metric of given dimension for a selected date range, the application would fetch all records from the database and calculate the sum by reading through the entire database, line by line. Examples: 1) Display the sum of the total amount spent for grocery in the last quarter, where “grocery” is a dimension and “amount” is a metric; 2) Display the number of unique visitors of a website in the last month where “visitors” is a dimension and “count of visitors” is a metric; 3) Display the number of ad impressions in the last month where “impressions” is a dimension and “count of the impressions” is a metric.

The line by line calculations may take a long time on large data sets, and the proposed algorithm within the present invention allows applications to fetch the aggregated historical data as quickly as possible without additional calculations. The present invention allows storing the data by dividing the information into several fixed date range layers, such as but not limited to, yearly, quarterly, monthly, weekly, and daily layers. In this way, the desired data is easily accessible and needs no further calculation or computation, from the application side, to obtain a specific or desired number.

### DESCRIPTION OF PRIOR ARTS

U.S. Pat. No. 6,954,722 B2 Methods and systems for data analysis. The present invention provides methods of analyzing and/or displaying data. In one aspect, the invention provides methods for visualizing or displaying high dynamic range data obtained from flow cytometry analyses. Related systems and computer programs products are also provided.

US20180068240A1 Method and apparatus for providing a bioinformatics database. A method, system and computer-readable medium for analyzing contact studies for a call service center is presented. The method includes the steps of acquiring data instances of a Collector tool from all persons monitoring contacts at a call service center during a given study period; retrieving a study design from a Planner tool to verify that acquired data instances conform to the study design; selecting data parameters for the acquired data instances, wherein the data parameters describe multiple features of the acquired data; automatically selecting an appropriate chart format that is appropriate for measurement units used by the data parameters; and creating a chart using the appropriate chart format and the data parameters. The steps in the method may all be automatically performed by an Analyzer logic.

U.S. Pat. No. 7,215,804 B2 System and method for organizing information relating to polymer probe array chips including oligonucleotide array chips. A database model is provided which organizes information relating to sample preparation, chip layout, application of samples to chips, scanning of chips, expression analysis of chip results, etc. The model is readily translatable into database languages such as SQL. The database model scales to permit mass processing of probe array chips.

U.S. Pat. No. 7,647,322 B2 System and method for retrieving and displaying data, such as economic data relating to salaries, cost of living and employee benefits. A system and method for retrieving and displaying data, such as economic data. The method can include receiving over a computer network a user request for a first item of economic data, retrieving the first item of economic data from a database, and providing a display description for view by the user over the computer network with the display description including the first item of economic data. The method can further include receiving a second item of economic data from the user over the computer network and at least reducing a fee from the user for receiving the first item of economic data. In another embodiment, the method can include displaying a plurality of discrete data items to the user and receiving a selection of one of the discrete data items from the user resulting from the user at least aligning a cursor on the graphical display with the selected discrete data item. The method can further include retrieving additional data corresponding to the selected discrete data item and providing instructions for displaying the additional data to the user.

US20200349281A1 Dynamic management of data with context-based processing. Techniques for using contextual information to manage data that is subject to one or more data-handling requirements are described herein. In many instances, the techniques capture or depend upon the contextual information surrounding the creation and/or subsequent actions associated with the data. The contextual information may be updated as the data is handled in various manners. The contextual information may be used to identify data-handling requirements that are applicable to the data, such as regulations, standards, internal policies, business decisions, privacy obligations,security requirements, and so on. The techniques may analyze the contextual information at any time to provide responses regarding handling of the data to requests from requestors, such as administrators, applications, and others.

U.S. Pat. No. 9,892,442 B2 Data processing systems and methods for efficiently assessing the risk of privacy campaigns. Data processing systems and methods, according to various embodiments, are adapted for efficiently processing data to allow for the streamlined assessment of the risk level associated with particular privacy campaigns. The systems may provide a centralized repository of templates of privacy-related question/answer pairings for various vendors, products (e.g., software products), and services. Different entities may electronically access the templates (which may be periodically updated and centrally audited) and customize the templates for evaluating the risk associated with the entities' respective business endeavors that involve the relevant vendors, products, or services.

U.S. Pat. No. 9,785,792 B2 Systems and methods for processing requests for genetic data based on client permission data. Methods and systems disclosed herein relate generally to processing data requests from external assessment systems. More specifically, an interface is availed to external assessment systems that accepts an identification of one or more genes. Upon receiving a request identifying one or more genes, a type of access authorized for the requesting external assessment system is assessed. When it is determined that the type of data access indicates that the external assessment system is authorized to access data for the one or more genes, a data repository is queried to identify client data that corresponds to the one or more genes and that indicates or can be used to detect a presence of client-associated variants. A response data set that includes at least some of the client data is transmitted to the external assessment system.

The present invention involves a historical data algorithm that segregates the information into date range layers. As a result, it helps in computation of historical data with shorter retrieval time that in turn boosts database performance, user experience, and software application sustainability. It uses a mechanism to store and compute historical data records using any date range, such as but not limited to, daily, weekly, bi-weekly, monthly, quarterly, half yearly, and yearly. This helps users/clients to fetch historical data faster and enhances system computational capabilities, without additional consumption of system resources. The present invention also helps reduce system processing time by limiting the system performance KPIs (key performance indicators) within a functioning network, and hence serves as an excellent point of focus. Under normal circumstances, numerous requests and responses within an application are not mandatory for the overall functionalities. The present invention with its unique application structure helps to minimize unwanted command codes in order to improve system response time to display the desired operational results.

The present invention fetches historical data with enhanced processing speed, without the need for additional calculation, by dividing and storing the data into several fixed dates range layers such as (but not limited to) yearly, quarterly, monthly, weekly, and daily layers. These segregated data can be accessed and saved into almost any type of data storage. The present invention also helps to curtail excessive use of power consumption by network elements, in turn reducing the cost involved in the energy consumption requirements estimated during the setup of the network. Thus, indirectly as it may seem, but still helping to reduce the application software's′ demand of power and time consumption required in the computation of large historical data.

### SUMMARY OF THE INVENTION

The following summary discloses all the features and functions of the present invention, by considering the whole specifications, claims, drawings and abstract, one can easily get a full understanding of the invention and how it functions.

The present invention is an algorithm for storing and accessing historical data, using date range layers. This approach is intended to aggregate almost any types of historical data such as but not limited to web server logs, network traffic, financial transactions, marketing data, or sports statistics into dates range layers which can be saved into almost any data storage making it easily accessible to aggregated data as quickly as possible without extra calculations.

The algorithm breaks up the data and aggregates it to fixed date range layers for specific dimension and metric. Each dimension has a layer, and that layer has its metrics. These operations can be executed as a standalone process without any extra load on existing applications and after aggregation, the data can be stored in any database. If the algorithm needs to get any data from a specific range, the algorithm can calculate it quickly using the already aggregated data. This algorithm maximizes efficiency and saves time by eliminating unnecessary calculations. When the applications need to get for example, the number of visitors for a specific date range, applications can get this number by summing the numbers from each layer. This algorithm can be implemented in almost any programming language such as but not limited to Python, C++, JavaScript, or Java.

### BRIEF DESCRIPTION OF FIGURES

FIG. 1 is a side view of the flowchart diagram of the invention algorithm

FIG. 2 is a usage example of the data layers of the invention algorithm.

### DETAILED DESCRIPTIONS OF FIGURES

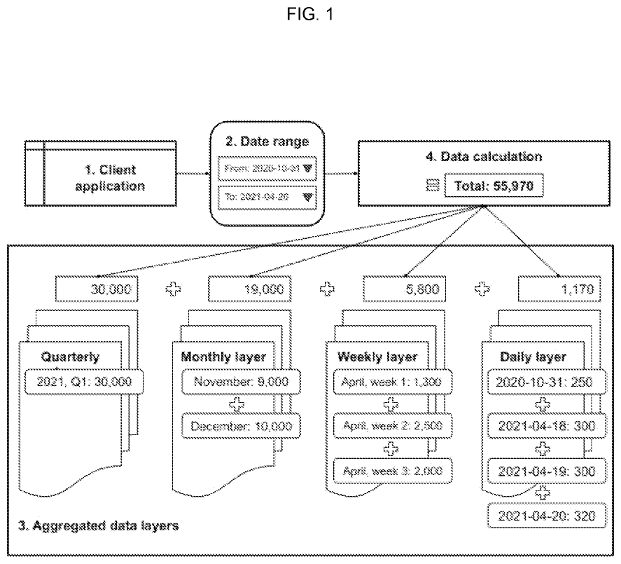

In FIG. 1, the invention discloses the incoming data information (1), the algorithm breaks up the data and aggregates it to fixed date range layers for specific dimensions and metrics (2), with each dimension having a layer, and that layer having its own metric. After aggregation the data can be stored in any database which is then processed and can be saved into almost any data storage (3), making it easily accessible. When the applications (4) need to get the data, for example, the number of visitors for a specific date range (5) the algorithm can get this number by summing the numbers from the already aggregated data from already prepared dates range layers (6).

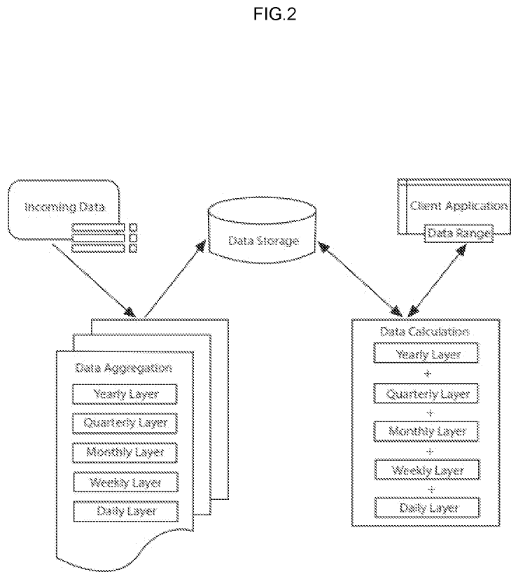

In FIG. 2, the invention discloses a sample application using this algorithm. A client application instruction (1), the date range selector (2), the aggregated data layers (3), and the calculation of total number (4).

The inventions claimed:

1. An algorithm for dates range layers for historical data is used for storing historical data into different date ranges.

2. An algorithm for dates range layers for historical data as in claim 1) is used to store historical data by segregating and aggregating it into fixed dates range layers.

3. An algorithm for dates range layers for historical data as in claim 1) is used to get historical data as quickly as possible without additional calculations.

4. An algorithm for dates range layers for historical data as in claim 1) is used to help reduce unnecessary software requests using segregated information from the dates range layers.

5. An algorithm for dates range layers for historical data as in claim 1) is used to save future implementation time by reusing already pre-calculated datasets of historical data.

6. An algorithm for dates range layers for historical data as in claim 1) is used to increase energy efficiency to help save excessive power consumption by utilizing less power in running software programs in fetching historical data.
